(19) United States
(12) Patent Application Publication
(10) Pub. No.: US 2013/0265607 A1
(43) Pub. Date: Oct. 10, 2013

(54) IMAGE FORMING APPARATUS, CONTROL METHOD FOR IMAGE FORMING APPARATUS, AND STORAGE MEDIUM

(71) Applicant: CANON KABUSHIKI KAISHA, Tokyo (JP)

(72) Inventor: Takaaki Miyata, Tokyo (JP)

(21) Appl. No.: 13/857,070

(22) Filed: Apr. 4, 2013

(30) Foreign Application Priority Data
Apr. 9, 2012 (JP) 2012-088150

(51) Int. Cl. G06K 15/00

(52) U.S. Cl. CPC G06K 15/406
USPC 358/1.15

(57) ABSTRACT

An image forming apparatus that executes an application to perform image formation processing, the image forming apparatus includes an instruction unit configured to instruct power supply through a supply unit to each component of an image forming apparatus, a shutoff unit configured to shut off electric power that the supply unit supplies to each component.

### BACKGROUND OF THE INVENTION

1. Field of the Invention

The present invention relates to an image forming apparatus, a control method for an image forming apparatus, and a storage medium.

2. Description of the Related Art

In recent years, in image forming apparatuses represented by multifunction peripherals (MFPs), power consumptions during ordinary use have been on an increasing trend. Furthermore, at the time of startup, the processing which consumes much power, such as temperature adjustment of a fixing unit, is concentrated. Therefore, in a case where many image forming apparatuses are introduced within one building, temporary power consumptions will be increased rapidly, if the image forming apparatuses start up simultaneously.

On the other hand, in a case where an image forming apparatus in operation is stopped without turning off a switch due to power failure or the like, the switch is already turned on at the time of power failure recovery. Therefore, power source will be turned on without performing any operation by a user. Under such a situation, in a case where many image forming apparatuses are introduced in one building, the image forming apparatuses start up simultaneously, and temporary power consumption is increased rapidly.

As a conventional technique, in a case where previous termination process is abnormal, there is a method in which ordinary startup processing is not performed in an information processing apparatus. For example, if abnormal termination process exceeds a predetermined value, ordinary startup processing is not performed but recovery process for returning to a state at the time of purchase is performed (refer to Japanese Patent Application Laid-Open No. 2006-215905).

However, in order to avoid the rapid increase of temporary power consumptions described above, it is determined whether the previous termination process is normal. If otherwise, it is necessary to normally terminate the image forming apparatus before performing the processing which consumes much power. Further, during power failure, subsequent power failure and power failure recovery may often occur, and therefore it is also important to keep the switch of the image forming apparatus turned off.

### SUMMARY OF THE INVENTION

The present invention is directed to providing a mechanism capable of recovering a state of a switch which instructs supply of electric power to a normal state, without the need to perform startup processing of components of an image forming apparatus, if the power is resupplied, in a case where supply of power is shut off in the last minute.

According to an aspect of the present invention, an image forming apparatus that executes an application to perform image formation processing, the image forming apparatus includes an instruction unit configured to instruct power supply through a supply unit to each component of an image forming apparatus, a shutoff unit configured to shut off electric power that the supply unit supplies to each component, a nonvolatile storage unit configured to store information indicating that power supply has been normally shut off by the shutoff unit, a determination unit configured, in a case where an instruction to change power supply state from off-state to on-state by the instruction unit is received, to determine whether information indicating that electric power has been normally shut off is stored in the nonvolatile storage unit, and a changing unit configured, in a case where the determination unit determines that information indicating that electric power has been normally shut off is not stored in the nonvolatile storage unit, to change a state of the instruction unit from on-state to off-state, wherein after the state of the instruction unit has been changed from on-state to off-state, electric power that the supply unit supplies to each component is shut off by the shutoff unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of an image forming system including an image forming apparatus according to the present exemplary embodiment.

FIG. 2 is a block diagram illustrating a configuration of a controller illustrated in FIG. 1.

FIGS. 3A and 3B are diagrams illustrating configurations of a power source and a power switch in the image forming apparatus illustrated in FIG. 1.

FIG. 4 is a block diagram illustrating an example of a power supply control circuit related to the controller illustrated in FIG. 1.

FIG. 5 is a diagram illustrating hierarchical structure of software that operates in the image forming apparatus illustrated in FIG. 1.

FIG. 6 is a flowchart illustrating a control method for the image forming apparatus.

FIG. 7 is a flowchart illustrating a control method for the image forming apparatus.

### DESCRIPTION OF THE EMBODIMENTS

Various exemplary embodiments, features, and aspects of the invention will be described in detail below with reference to the drawings.

### Descriptions of System Configuration

A first exemplary embodiment will be described.

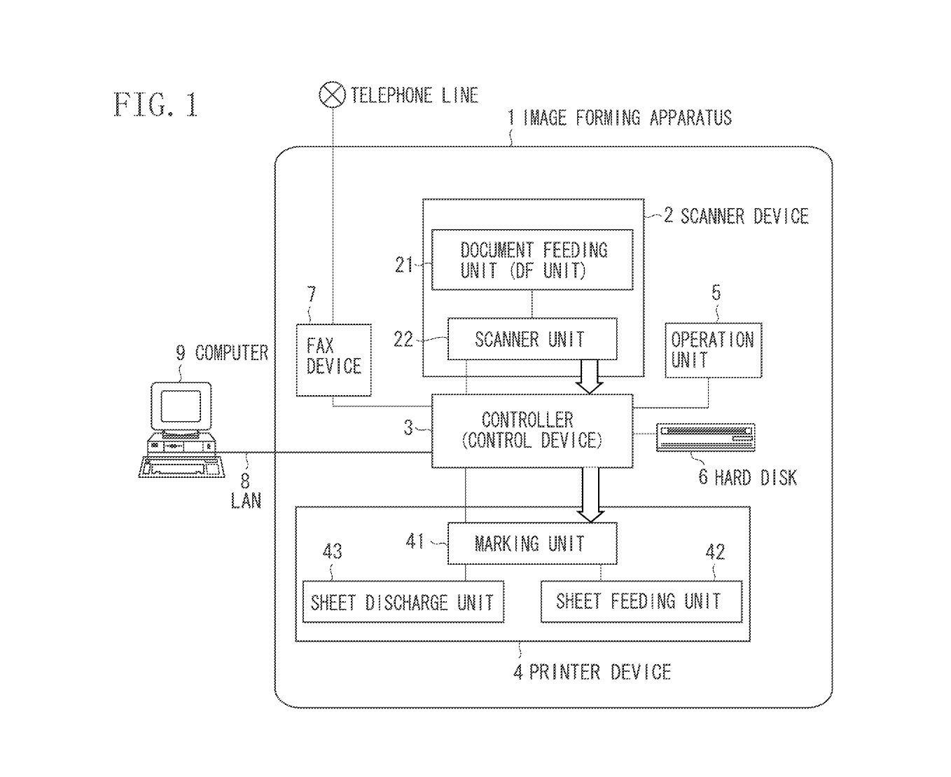

FIG. 1 is a diagram illustrating an example of an image forming system including an image forming apparatus according to the present exemplary embodiment. The example represents a case in which the image forming apparatus is constituted of MFP provided with composite image processing functions, but the present invention can be also applied to a printer apparatus, a facsimile apparatus, and the like.

In FIG. 1, an image forming apparatus 1 includes a scanner device 2 that optically reads an image from a document and converts it into digital image, a printer device 4 that outputs the digital image on a sheet device, and the like.

An operation unit 5 has a display device and performs operation of the apparatus. A hard disk 6 stores digital images and control programs and the like. A FAX device 7 transmits or receives digital images to or from a telephone line or the like. A controller 3 comprehensively controls the scanner device 2, the printer device 4, the operation unit 5, and the FAX device 7. The controller 3 is connected to the above-described respective devices and is configured to be capable of executing jobs on the image forming apparatus 1 by issuing instructions to respective modules.

The image forming apparatus 1 is capable of performing input/output of digital images from a computer 9 by a network controller provided to the controller 3 via a local area network (LAN) 8, issuing jobs and designating equipment or the like.

The scanner device 2 is provided with a document feeding unit 21 capable of automatically and sequentially replacing document bundles. Further, the scanner device 2 includes a scanner unit 22 capable of optically scanning the documents and converting them into digital images. The converted image data is transmitted to the controller 3.

The printer device 4 includes a sheet feeding unit 42 capable of feeding sheets one by one from the sheet bundle, a marking unit 41 for printing the image data on the fed sheet, and a sheet discharge unit 43 for discharging the sheet after printing.

The image forming apparatus 1 is capable of executing the following functional processing for a wide variety of job processes. An example will be described as follows.

### Copying Function

Store images read from the scanner device 2 on the hard disk (HDD) 6, and at the same time perform printing using the printer device 4.

### Image Transmission Function

Transmit images read from the scanner device 2 to the computer 9 via the LAN 8.

### Image Saving Function

Store images read from the scanner device 2 on the HDD 6, and perform image transmission or image printing as needed.

### Image Printing Function

Analyze page description languages, for example, transmitted from the computer 9, and print them using the printer device 4.

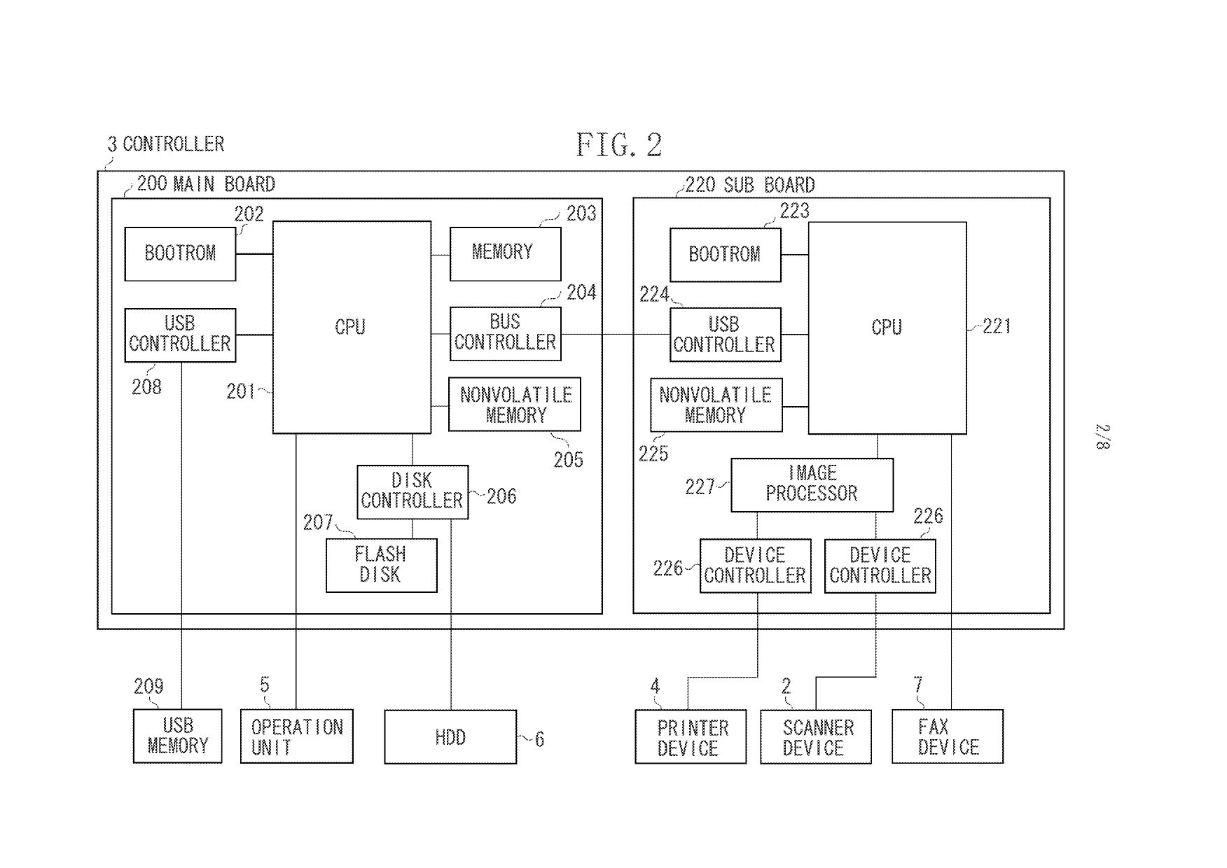

FIG. 2 is a block diagram illustrating a configuration of the controller 3 illustrated in FIG. 1. The controller 3 serving as a module which specifically applies the present invention will be described with reference to FIG. 2.

In FIG. 2, the controller 3 includes a main board 200 and a sub-board 220.

The main board 200 is a general-purpose central processing unit (CPU) system, and is provided with a CPU 201 that controls the entire board, a boot read-only memory (ROM) 202 in which a boot program is included, and a memory 203 that is used as a work memory by the CPU. Furthermore, the main board 200 is provided with a bus controller 204 that has bridge function with an external bus, a nonvolatile memory 205 that is non-erasable even if power is shut off, and a disk controller 206 that controls storage devices.

Furthermore, the main board 200 is provided with a flash disk 207 which is a storage device with relatively small capacity composed of semiconductor devices, and a universal serial bus (USB) controller 208 capable of controlling USB.

A USB memory 209, the operation unit 5, and the hard disk device (HDD) 6 are externally connected to the main board 200.

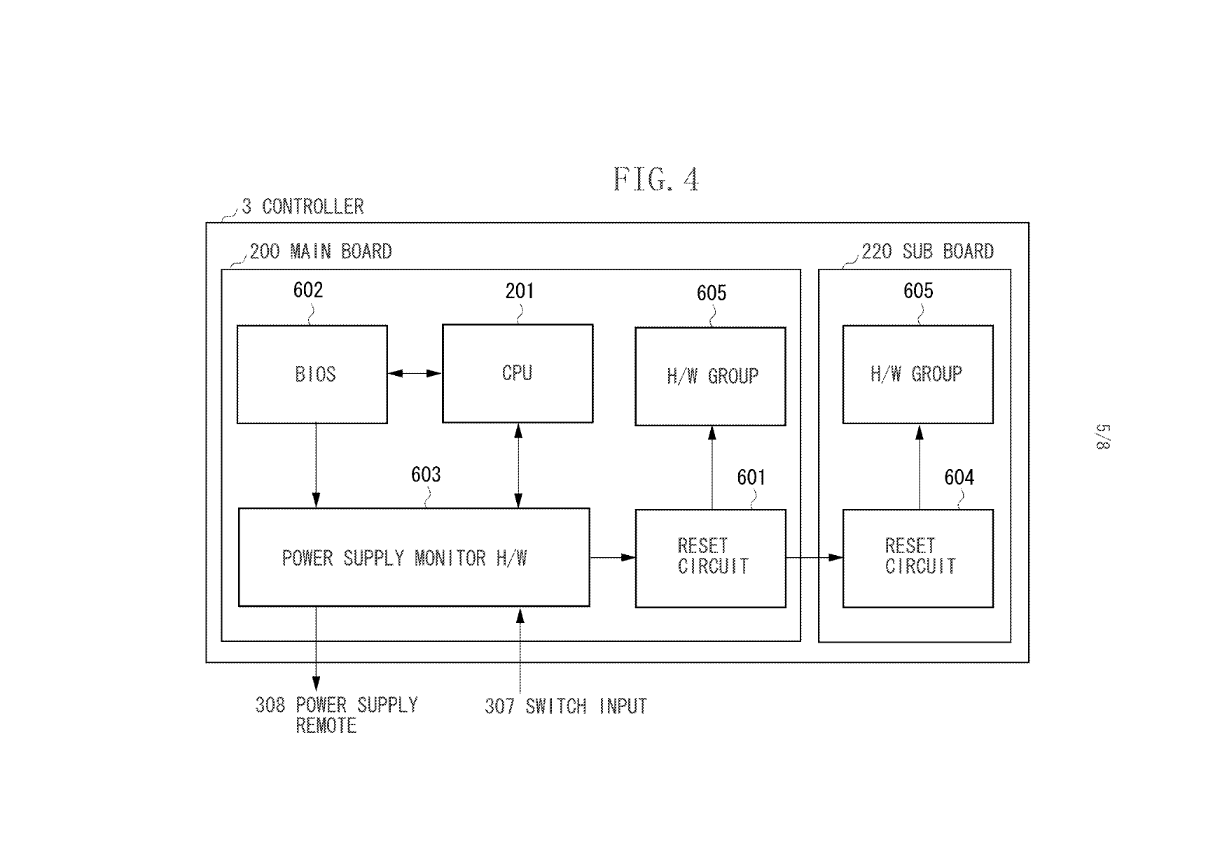

The nonvolatile memory 205 can store information before power is shut off, and can read the information at the time of the next energization. The nonvolatile memory 205 is used as a nonvolatile storage unit that stores information indicating that supply of power to a reset circuit 601 (FIG. 4) has been normally shut off.

The sub-board 220 is constituted of a relatively small general-purpose CPU system, and an image processing hardware, and is provided with a CPU 221 that controls the entire board, and a memory 223 which the CPU uses as a work memory.

Furthermore, the sub-board 220 is provided with a bus controller 224 having a bridge function with an external bus, and a non volatile memory 225 that is non-erasable even if power is shut off. Furthermore, the sub-board 220 is provided with an image processor 227 that performs real time digital image processing and device controllers 226.

The scanner device 2 and an external printer device 4 perform transfer of digital image data, via the device controller 226. The CPU 221 performs direct control of the FAX device 7.

FIG. 2 is a block diagram, which is simplified. For example, in the CPU 201 and the CPU 221, many pieces of CPU peripheral hardware such as chip sets, bus bridges, clock generators are included, but they are not necessary in terms of granularity of descriptions, and therefore they are described simplistically, and the block configuration is not intended to restrict the present invention.

An operation of the controller 3 will be described taking image copying by a paper device as an example.

If the user instructs image copying from the operation unit 5, the CPU 201 sends an image reading command via the CPU 221 to the scanner device 2. The scanner device 2 optically scans paper document to convert the paper document into digital image data and inputs the digital image to the image processor 227 via the device controller 226. The image processor 227 performs direct memory access (DMA) transfer to the memory 223 via the CPU 221 and temporarily stores digital image data.

If the CPU 201 confirms that the memory 223 has contained a certain amount of or all of digital image data, the CPU 201 issues an image-output instruction to the printer device 4 via the CPU 221. The CPU 221 teaches positions of the image data of the memory 223 to the image processor 227. The image data on the memory 223 is transmitted to the printer device 4 via the image processor 227 and the device controller 226 in accordance with synchronizing signal from the printer device 4, and the digital image data is printed on a paper device by the printer device 4.

In a case where printing of a plurality of copies is performed, the CPU 201 stores the image data of the memory 223 on the hard disk 6, and it is possible to send the images to the printer device 4 even if images are not received from the scanner device 2 for the second copy and beyond.

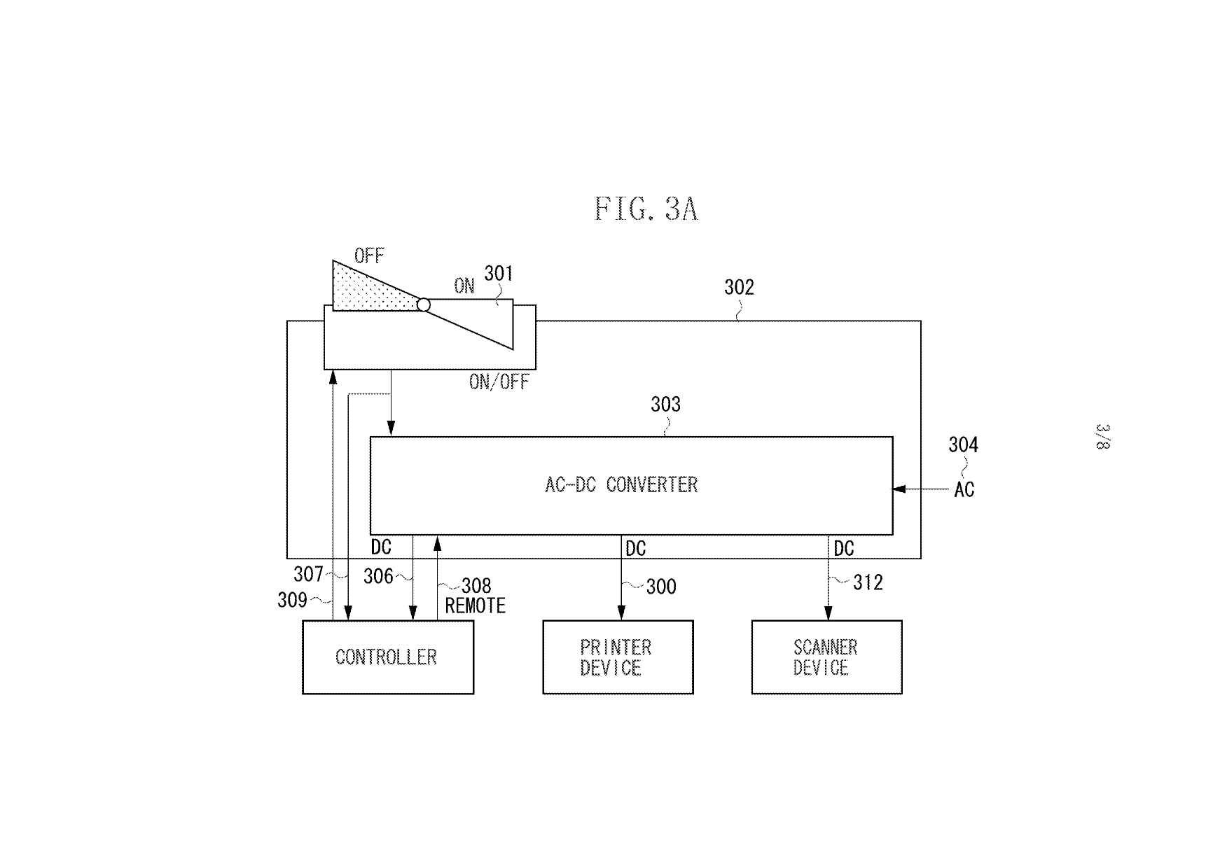

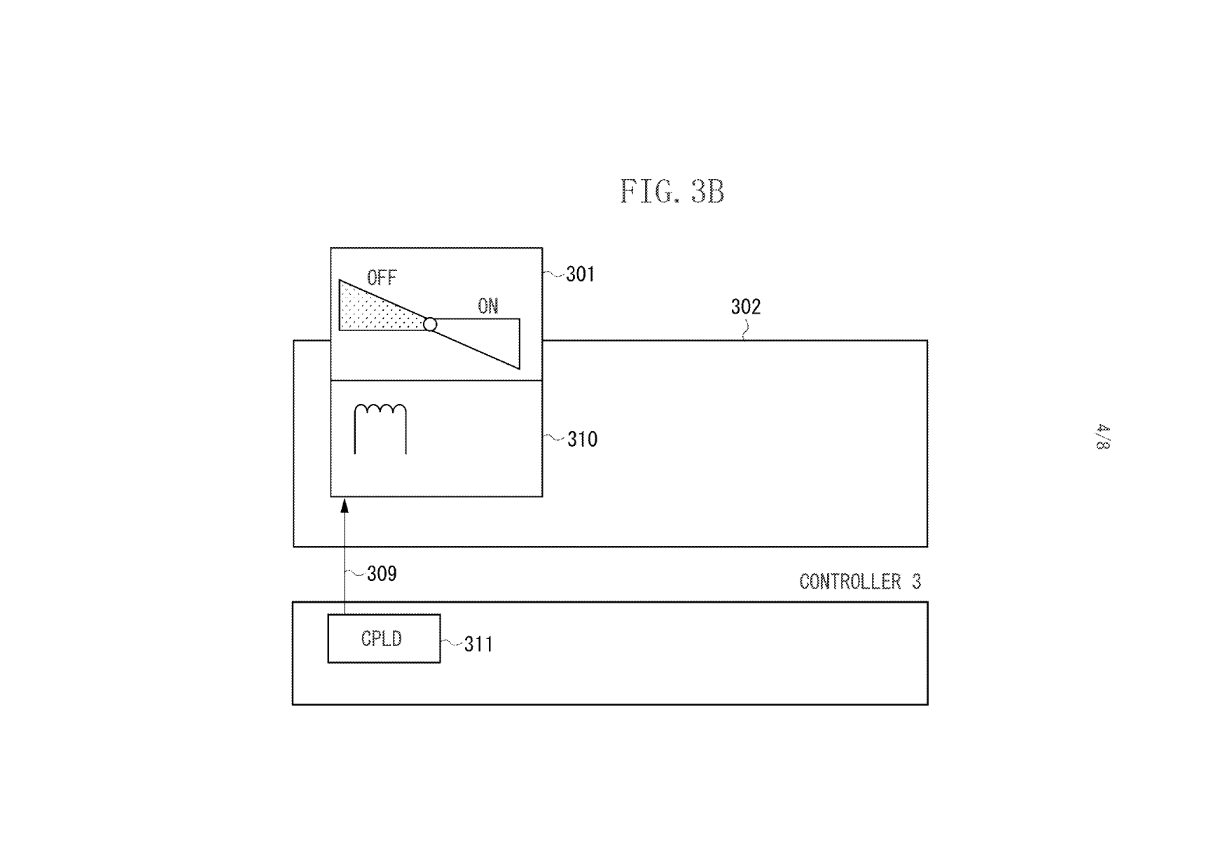

FIGS. 3A and 3B are diagrams illustrating configurations of a power source and a power switch in the image forming apparatus 1 illustrated in FIG. 1.

In FIG. 3A, a toggle type power-saving/power switch 301 is a switch that continues to mechanically hold either state of ON- and OFF-states. An operator inputs a state by tilting down toward either side of ON/OFF. Further, the power-saving/power switch 301 has a solenoid in the interior. A magnetic force is generated by applying voltage to the solenoid, and thereby the ON- and OFF-states of the power-saving/power switch 301 can be changed. The power-saving/power switch 301 works as a switch that toggles ON-state or the OFF-state.

A power supply unit 302 is provided with an AC-DC converter 303, which converts commercial power supply input from an AC power input unit 304 into DC power associated with each component. A power cable 300 is used to supply DC power to the printer device 4. Power cables 306 and 312 are used to supply power to the controller 3, and the scanner device 2, respectively.

A line 307 is used to notify the controller of a state of the toggle type power-saving/power switch 301. A power remote signal 308 is used to control an output of the AC-DC converter 303.

FIG. 3B illustrates in detail a portion of the power supply unit 302 and the controller 3 related to the power-saving/power switch 301.

By energizing a solenoid 310 in FIG. 3B, a magnetic force can be generated in the vicinity of the power-saving/power switch 301, and furthermore, ON- and OFF-states of the power-saving/power switch 301 can be changed.

A complex programmable logic device (CPLD) 311 is connected to the solenoid 310 via a signal line 309. In other words, it is configured such that a drive of the solenoid 310 can be controlled according to an instruction from the CPLD 311. Accordingly, by changing a state of the CPLD 311, ON- and OFF-states of the power-saving/power switch 301 can be changed. In the present exemplary embodiment, the CPLD 311 is used for the drive control of the solenoid 310, but as long as it is a device which can energize other apparatus by changing a state, the device is not limited to CPLD.

Of course, the operator can also turn ON/OFF the apparatus by operating the toggle type power-saving/power switch 301.

The power-saving/power switch 301 is connected to the AC-DC converter 303 during ON-state and can control energized state of the power source.

During the OFF-state, supply from power cable 306 must not stop until shutdown of the system is completed by the controller 3. In other words, the controller 3 is designed to notify the controller 3 of a state of the power-saving/power switch 301 via the line 307, and to turn off power supply from the power cable 306 using the power remote signal 308 which is notified via the line 307 after the shutdown has been completed.

These descriptions cover power source configuration possessed by general devices that necessitate the shutdown.

FIG. 4 is a block diagram illustrating a power control circuit example related to the controller 3 illustrated in FIG. 1. In the example, a circuit example focused on the periphery of a reset circuit is illustrated.

In FIG. 4, a reset circuit 601 is provided on the main board 200. A basic input/output system (BIOS) 602 controls basic portions of hardware (H/W) on the main board 200. A dedicated H/W logic 603 monitors power control of the system. In a case of an application specific integrated circuit (ASIC) or the like, a small CPU system or the like may be used. A reset circuit 604 is provided on the sub-board 220. A H/W group 605 is provided for each board.

Since synchronous type H/W resets an internal state, based on reset instruction from the reset circuit 601, an H/W circuit set up with the synchronous type is configured such that the reset circuits 601 and 604 need to reset respective H/W after power has been supplied to each chip after power-on.

Further, since a plurality of H/W chips has a master-slave relationship, a reset sequence will be designed so as to sequentially apply a reset. For this end, generally as illustrated in the present exemplary embodiment, one reset circuit is included in one board, and each reset circuit will perform reset operation within each board.

A system of the main board 200 is a main board especially in the apparatus, and has the power supply monitor H/W unit 603. The power supply monitor H/W unit 603 is used to input a state of the power-saving/power switch 301 from the line 307. The power supply monitor H/W unit 603 has a function of being capable of controlling power supply in the main board 200 using the power supply remote line 308.

In a case where the CPU 201 can normally operate, a reset can be applied to the system in accordance with an instruction of the CPU 201. Further, in a state where power is not supplied to the CPU 201, the controller 3 can be powered on by controlling the power supply remote signal 308 from an input of the line 307.

The BIOS 602 is a system in which H/W control library or the like at a low level is included. This is designed to secure compatibility of an IBM compatible machine.

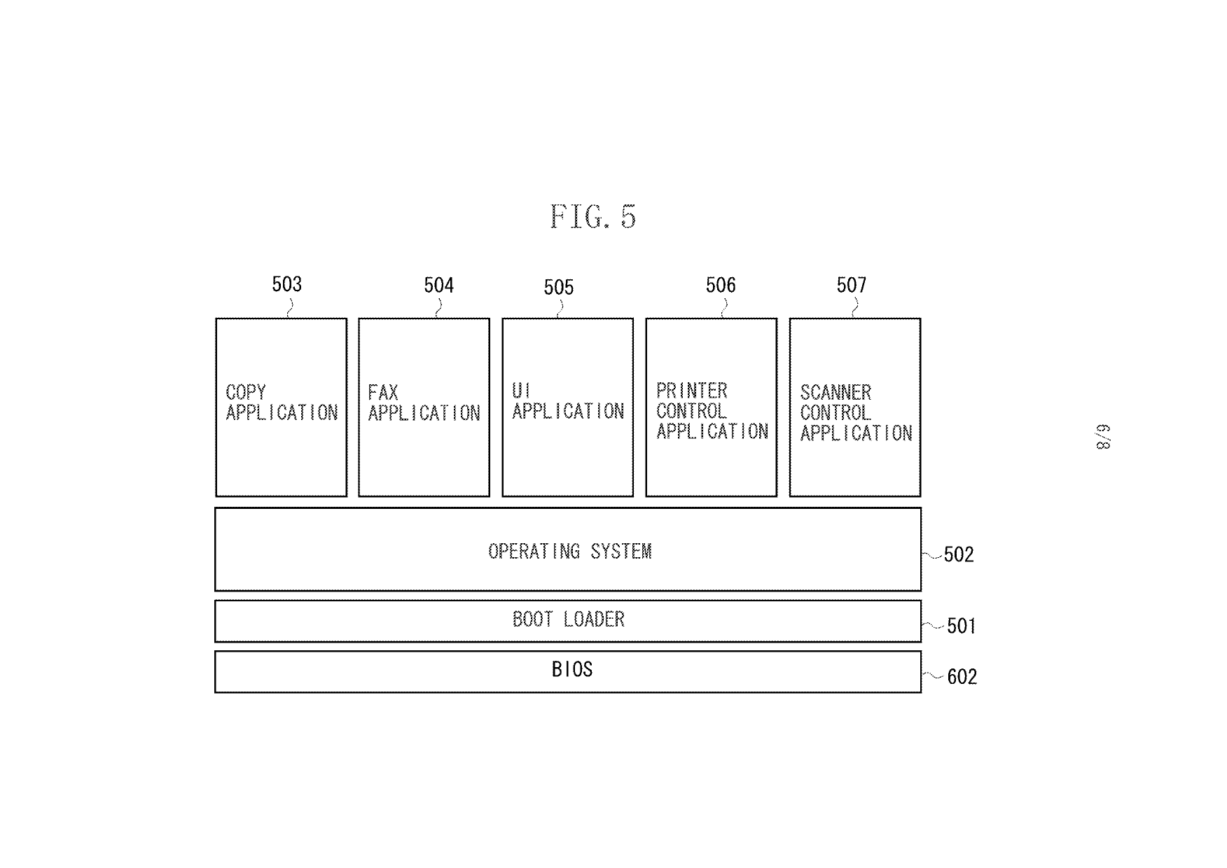

FIG. 5 is a diagram illustrating a hierarchical structure of software that operates in the image forming apparatus illustrated in FIG. 1. The image forming apparatus 1 according to the present exemplary embodiment executes respective applications described below to perform the image formation processing.

In FIG. 5, the BIOS 602 is software which is executed first at the time of startup of the image forming apparatus, and performs initialization of the H/W at a low level, for example. Subsequently a boot loader 501 is executed. In this process, the boot loader 501 performs initialization of the H/W, and loads an operating system 502 stored in the HDD 6, on the memory 203.

Thereafter, the operating system 502 is activated. Accordingly, memory management and device driver comes into operation, and applications become able to be executed. Thereafter, an as needed application group is activated.

The above-described application group includes:
a copy application 503 for performing copying,
a FAX application 504 that performs control of the FAX device 7,
a UI application 505 that displays graphic user interface, on a display unit included in the operation unit 5,
a printer control unit application 506 that performs initialization and control of the printer device 4, and temperature adjustment of the engine portion included in the printer device 4, and
a scanner control application 507 that performs initialization and control of the scanner device 2.

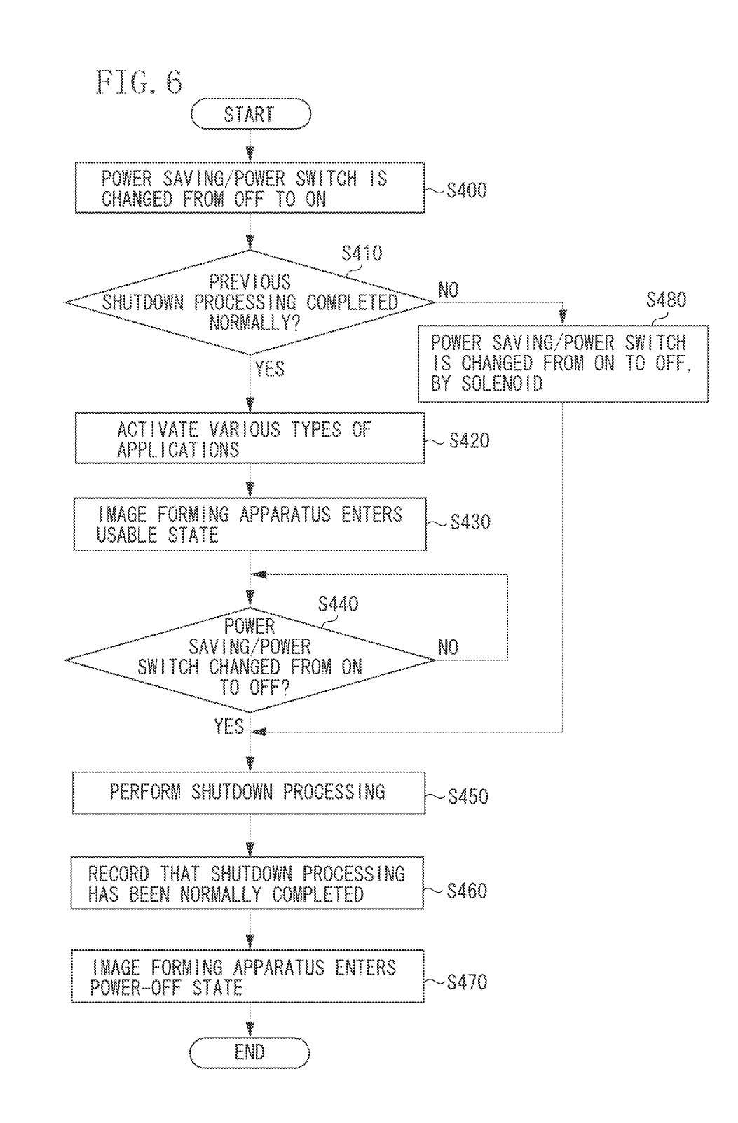

FIG. 6 is a flowchart illustrating a control method for the image forming apparatus according to the present exemplary embodiment. The example corresponds to startup operation example of the image forming apparatus according to a result of the previous shutdown processing. Each step is realized by the CPU 201 within the controller 3 of the image forming apparatus 1 executing operation, in accordance with a program stored in the HDD 6 or the flash disk 207. Hereinbelow, in a case where an instruction to change power supply state by the power-saving/power switch 301 from OFF-state to ON-state has been received, processing for determining whether information indicating that power has been normally shut off is stored in the nonvolatile memory 205, and changing a state of the power-saving/power switch 301 from the ON-state to the OFF-state will be described in detail.

Further, in the example, the power-saving/power switch 301 performs read/write access to the nonvolatile memory 205, in order to perform creation of/reference to necessary information at the time of startup.

In step S400, the power-saving/power switch 301 is changed from OFF to ON, with respect to the image forming apparatus 1 which is not powered on.

In step S410, the CPU 201 identifies whether the previous shutdown processing has been normally performed in reference to the nonvolatile memory 205, at a stage until the operating system activation. If normally performed (YES in step S410), the processing proceeds to step S420. If otherwise performed (NO in step S410), the processing proceeds to step S480.

Next, in step S420, the CPU 201 activates various types of applications of the image forming apparatus 1. In this process, the CPU 201 activates all the applications illustrated in FIG. 5. Therefore, processing which consumes much power such as temperature adjustment of the fixing device is included therein.

Next, in step S430, the image forming apparatus 1 enters usable state. Thereafter, in a case where ordinary shutdown is performed, the user instructs the power-saving/power switch 301 to change to the OFF-state. Thus, in step S440, the CPU 201 determines whether the power-saving/power switch 301 has been changed from the ON-state to the OFF-state. In this process, if the CPU 201 determines that the switch has been normally changed to OFF instruction (YES in step S440), the processing proceeds to step S450. If it is determined as otherwise changed (NO in step S440), the processing returns again to step S440.

Next, in step S450, the CPU 201 causes the power monitor H/W 603 to drive the reset circuit 601 to perform ordinary shutdown processing. Then, in step S460, the CPU 201 stores that shutdown processing has been normally completed, on the nonvolatile memory 205 within the main board 200. In step S470, the image forming apparatus 1 enters power-off state, and terminates the processing.

On the other hand, in step S480, since the previous shutdown processing has not been normally terminated, the power-saving/power switch 301 is changed from ON state to OFF state by the solenoid 310, then the processing proceeds to step S450 where shutdown processing is performed. Specifically, by driving the solenoid 310 to attract OFF portion side of the power-saving/power switch 301, the power-saving/power switch 301 is changed from the ON-state to the OFF-state. A driving method is an example, and in a case where the ON-state is configured to be pulled by other member, drive of the solenoid 310 may be a pull action.

Accordingly, it becomes possible to establish matching between power source states of the power-saving/power switch 301 and the image forming apparatus 1.

Before coming to the processing in step S46, in the flow, in a case where shutdown processing is not performed due to cause such as power failure, or shutdown processing is abnormally terminated, it is not stored in the nonvolatile memory 205 that shutdown processing has been normally terminated. In this case, if next time the power-saving/power switch 301 is changed from OFF to ON, by always passing through the processing in step S480, the image forming apparatus 1 is stopped without performing startup processing which consumes much power, and the switch can be also turned to OFF.

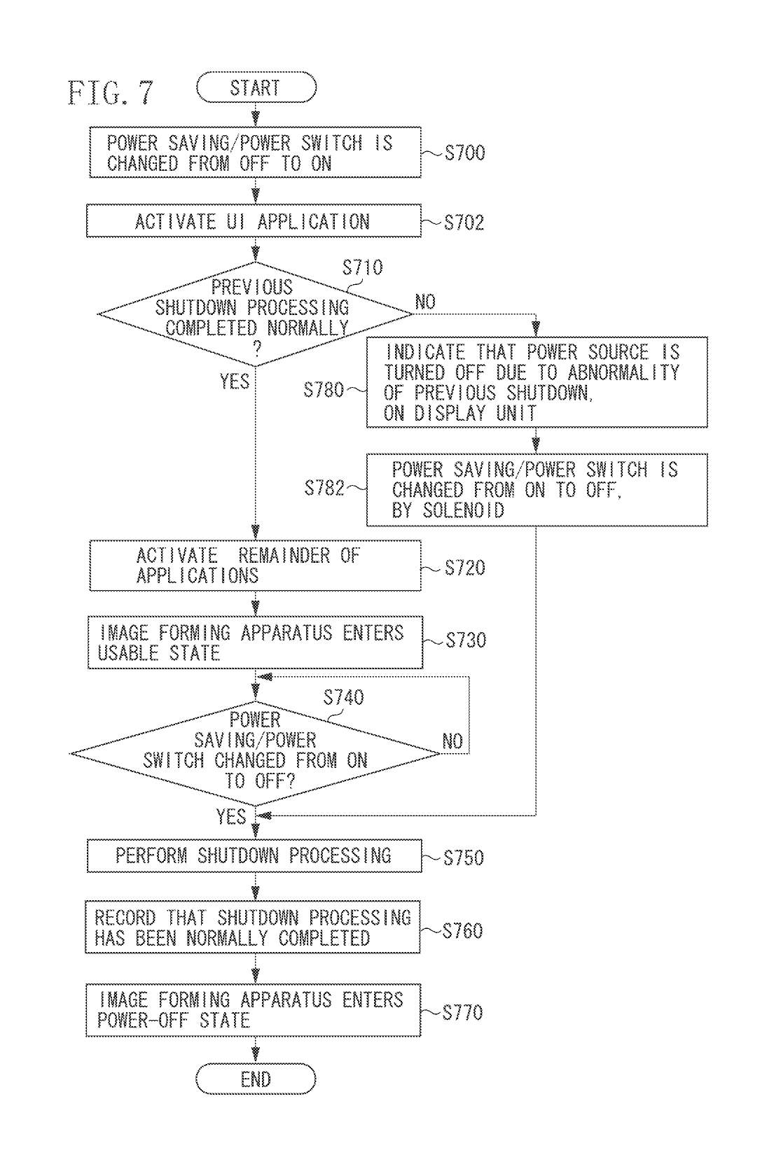

A second exemplary embodiment will be described. The present exemplary embodiment will be described with reference to FIG. 1, FIG. 2, FIG. 3, FIG. 4, FIG. 5, and FIG. 7.

In the present exemplary embodiment, if the previous shutdown processing is not normally terminated in the image forming apparatus, rather than immediately performing shutdown, information that power is cut off since the previous shutdown is abnormal is output to the display unit on the operation unit 5.

At that time, output to the display unit of the operation unit 5 is performed by the UI application 505, and in advance of startup of the UI application 505, any processing which consumes much power, such as temperature adjustment of the fixing device, is never performed.

Accordingly, even if reactivation of power is performed to the image forming apparatus in which the previous shutdown processing is not normally terminated, and the user is monitoring the display unit at that time, the user will become able to figure out the reason why startup processing is not directly performed and power is cut off. Others are similar to the first exemplary embodiment.

FIG. 7 is a flowchart illustrating a control method for the image forming apparatus according to the present exemplary embodiment. The example corresponds to startup operation example of the image forming apparatus according to a result of the previous shutdown processing. Each step is realized by the CPU 201 within the controller 3 of the image forming apparatus 1 executing operation, in accordance with a program stored in the HDD 6 or the flash disk 207.

Further, the CPU 201 performs read/write access to the nonvolatile memory 205 in order to perform creation of/reference to necessary information at the time of startup.

In step S700, the power-saving/power switch 301 is changed from the OFF-state to ON-state, with respect to the image forming apparatus 1 which is not powered on.

In step S702, the CPU 201 performs startup of the UI application 505 after operating-system startup. Accordingly, the CPU 201 becomes able to output character strings or images to the display unit on the operation unit 5.

In step S710, the CPU 201 determines whether the previous shutdown processing has been normally performed in reference to the nonvolatile memory 205. If it is determined that the previous shutdown processing has been normally performed (YES in step S710), the processing proceeds to step S720. If it is determined that the previous shutdown processing has not been normally performed (NO in step S710), the processing proceeds to step S780.

In step S720, the CPU 201 activates the remainder of various types of the applications of the image forming apparatus 1. In this case, the CPU 201 activates all the applications except for the UI application 505, illustrated in FIG. 5. Therefore, the processing which consume much power, such as the temperature adjustment of the fixing device, are included therein.

In step S730, the image forming apparatus 1 enters usable state. In step S740, the CPU 201 identifies whether the power-saving/power switch 301 has been changed from the ON-state to the OFF-state. If the CPU 201 determines that the switch has been changed (YES in step S740), the processing proceeds to step S750. If the CPU 201 determines that the switch has not been changed (NO in step S740), the processing returns again to step S740.

In step S750, the CPU 201 causes the power monitor H/W 603 to drive the reset circuit 601 to perform ordinary shutdown processing. In step S760, the CPU 201 stores that the shutdown processing has been normally terminated on the nonvolatile memory 205. In step S770, the image forming apparatus 1 enters power-off state.

In step S780, the CPU 201 displays that power is to be cut off due to abnormality of the previous shutdown, on the display unit on the operation unit 5.

Accordingly, the user who monitors the display unit becomes able to figure out the reason why shutdown processing is performed after the previous shutdown has been performed.

In step S782, since the previous shutdown processing has not been normally terminated, the power-saving/power switch 301 is changed from the ON-state to the OFF-state by a solenoid. Then the processing proceeds to step S750 where shutdown processing is performed.

Accordingly, it becomes possible to establish matching between power source states of the power-saving/power switch 301 and the image forming apparatus 1. In other words, as a result of identifying a case where power has been normally shut off, and a case at power-on after sudden shutdown such as power failure has been executed, if it is found that power has been normally shutdown, shutdown processing is executed without starting power supply to members with high consumed power of an engine portion (including the fixing device). In a case where shutdown is not been normally executed, in this way, matching processing between the state of the power-saving/power switch 301 and the shutdown state can be completed at a low electric power state.

Before coming to the processing in step S760, in the flow, in a case where shutdown processing is not performed due to cause such as power failure, or in a case where shutdown processing has been abnormally terminated, it is not stored on the nonvolatile memory that shutdown processing has been normally terminated.

In this case, if next time the power-saving/power switch 301 is changed from OFF to ON, by passing through the process of step S782, exactly, the image forming apparatus 1 can be stopped without performing startup processing which consumes much power, and the switch can be turned to OFF.

Furthermore, even if power reactivation is performed to the image forming apparatus 1 in which the previous shutdown processing has not been normally terminated, and the user is monitoring the display unit at that time, the user becomes able to figure out the reason why startup processing is not directly performed and power source is cut off.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-088150, filed Apr. 9, 2012 which is hereby incorporated by reference herein in its entirety.

What is claimed is:

1. An image forming apparatus that executes an application to perform image formation processing, the image forming apparatus comprising:
an instruction unit configured to instruct power supply through a supply unit to each component of an image forming apparatus;
a shutoff unit configured to shut off electric power that the supply unit supplies to each component;
a nonvolatile storage unit configured to store information indicating that power supply has been normally shut off by the shutoff unit;
a determination unit configured, in a case where an instruction to change power supply state from off-state to on-state by the instruction unit is received, to determine whether information indicating that electric power has been normally shut off is stored in the nonvolatile storage unit; and
a changing unit configured, in a case where the determination unit determines that information indicating that electric power has been normally shut off is not stored in the nonvolatile storage unit, to change a state of the instruction unit from on-state to off-state,
wherein after the state of the instruction unit has been changed from on-state to off-state, electric power that the supply unit supplies to each component is shut off by the shutoff unit.

2. The image forming apparatus according to claim 1, wherein the instruction unit is a switch that toggles on-state or off-state.

3. The image forming apparatus according to claim 1, further comprising a display unit configured, in a case where the determination unit determines that information indicating that power has been normally shut off is not stored in the nonvolatile storage unit, to display that electric power that the supply unit supplies to each component is shut off.

4. The image forming apparatus according to claim 1, wherein in a case where the determination unit determines that information indicating that power has been normally shut off is not stored in the nonvolatile storage unit, a state of the instruction unit is changed from on-state to off-state, before executing the application.

5. A control method for an image forming apparatus that executes an application to perform image formation processing, the control method comprising:
instructing power supply through a supply unit to each component of an image forming apparatus;
shutting off electric power that the supply unit supplies to each component;
storing information indicating that power supply has been normally shut off by the shutoff unit in a nonvolatile storage unit;
determining, in a case where an instruction to change power supply state from off-state to on-state by the instruction unit is received, whether information indicating that electric power has been normally shut off is stored in the nonvolatile storage unit; and
changing, in a case where the determining determines that information indicating that electric power has been normally shut off is not stored in the nonvolatile storage unit, a state of the instructing from on-state to off-state,
wherein after the instructing has been changed from on-state to off-state, electric power that the supply unit supplies to each component is shut off by the shutting off.

6. A non-transitory computer-readable storage medium storing a program for causing a computer to execute the control method for the image forming apparatus according to claim 5.
